(19) United States
(12) Patent Application Publication
(10) Pub. No.: US 2014/0182735 A1
(43) Pub. Date: Jul. 3, 2014

(54) THERMOPLASTIC EXTRUSION WITH VAPOR BARRIER AND SURFACE SULFONATION

(71) Applicant: THERCOM HOLDINGS, LLC, BLOOMFIELD HILLS, MI (US)

(72) Inventor: Joel A. Dyksterhouse, Cheboygan, MI (US)

(73) Assignee: THERCOM HOLDINGS, LLC, BLOOMFIELD HILLS, MI (US)

(21) Appl. No.: 13/729,115

(22) Filed: Dec. 28, 2012

(51) Int. Cl. F16L 9/14

(52) U.S. Cl. CPC F16L 9/14
USPC 138/141; 156/187

(57) ABSTRACT

A reinforced thermoplastic extrusion and a related method of manufacture are provided. The reinforced thermoplastic extrusion includes an extruded polymeric member, a thermoplastic reinforcing layer, and an intermediate vapor barrier between the extruded polymeric member and the thermoplastic reinforcing layer. The intermediate vapor barrier is bonded to the exterior of the extruded polymeric member and/or the interior of the thermoplastic reinforcing layer to limit the transfer of volatile hydrocarbons therethrough. Surface sulfonation can additionally be included to decrease the permeability of the thermoplastic extrusion to volatile hydrocarbons and other gases that can affect the performance of the outer thermoplastic reinforcing layer.

### BACKGROUND OF THE INVENTION

The present invention relates to high-pressure thermoplastic pipe including a reinforcing overwrap.

Thermoplastic extrusions such as pipes are in many instances overwrapped with a reinforcing material for high pressure applications. For example, a thermoplastic composite overwrap can be bonded to the exterior of an extruded thermoplastic pipe. In use, the overwrap can improve the ability of the extruded thermoplastic pipe to transport a moving fluid at high pressures, including up to 100 bar in some applications.

Under high pressures, volatile hydrocarbons transported through the extruded thermoplastic pipe can migrate through the pipe sidewall and chemically attack the thermoplastic overwrap, degrading the overall performance of the overwrap in time. In other instances, agents that are added to aid in extrusion or performance can inhibit the bonding of the reinforcing overwrap to the thermoplastic pipe. The same interaction can also cause de-bonding between a coiled pipe and a reinforcing overwrap.

Accordingly, there remains a need for an improved system that limits these and other effects of volatile hydrocarbons on reinforced thermoplastic extrusions, including for example reinforced extruded thermoplastic pipe. In addition, there remains a continued need for an improved system and method to leverage the benefits of reinforced extrusions across a wide range of applications involving volatile hydrocarbon and relatively high pressures.

### SUMMARY OF THE INVENTION

Reinforced thermoplastic extrusions and related methods of manufacture are provided. The reinforced thermoplastic extrusions include an inner thermoplastic pipe and an outer thermoplastic reinforcing layer. In some embodiments, a vapor barrier is included between the inner thermoplastic pipe and the thermoplastic reinforcing layer. In other embodiments, a surface sulfonation process is applied to the inner surface of the thermoplastic pipe and/or to the outer surface of the thermoplastic pipe. The surface sulfonation process decreases the permeability of the inner thermoplastic pipe to volatile hydrocarbons and other gases that might affect the performance of the outer thermoplastic reinforcing layer.

In one embodiment, a method for forming a reinforced thermoplastic extrusion is provided. The method includes extruding a polymeric material as a tubular member, co-extruding with the tubular member a vapor barrier, and overwrapping the tubular member and the vapor barrier with a thermoplastic reinforcing layer. The vapor barrier can include organic vapor transmission barriers, including for example ethylene vinyl alcohol, and inorganic vapor transmission barriers, including for example graphene. The vapor transmission barriers can individually or collectively reduce the transfer of volatile hydrocarbons into the thermoplastic reinforcing layer.

In another embodiment, a method for forming a reinforced thermoplastic extrusion includes extruding a polymeric material into a tubular member, applying a vapor barrier film to the exterior surface of the tubular member, and overwrapping the tubular member and the vapor barrier film with a thermoplastic reinforcing layer. This method and the above method can additionally include applying a sulfurization treatment and/or a corona treatment to the tubular member to improve the bonding between the tubular member and the vapor barrier film. Additional bonding agents can include inorganic additives and organic additives such as maleic anhydride and/or a functional polymer.

In still another embodiment, a method for forming a reinforced thermoplastic extrusion includes activating a surface of the thermoplastic extrusion to diminish the transfer of volatile hydrocarbons therethrough. This method can include a surface sulfonation of the exterior of the thermoplastic extrusion, the interior of the thermoplastic extrusion, or both of the interior and exterior of the thermoplastic extrusion. In this embodiment, the method includes overwrapping a thermoplastic reinforcing layer about the thermoplastic extrusion, where the thermoplastic reinforcing layer is optionally in direct contact with the thermoplastic without the addition of one or more tie layers therebetween.

In still another embodiment, a reinforced thermoplastic extrusion is provided. The reinforced thermoplastic extrusion includes an extruded polymeric member, a thermoplastic reinforcing layer, and an intermediate vapor barrier interposed between the extruded polymeric member and the thermoplastic reinforcing layer. The intermediate vapor barrier is bonded to the exterior of the extruded polymeric member and/or the interior of the thermoplastic reinforcing layer to limit the transfer of volatile hydrocarbons therethrough. The intermediate vapor barrier can include an elastomer to increase the elongation-to-break ratio of the reinforced thermoplastic extrusion, particularly though not necessarily where the thermoplastic extrusion is a coiled pipe.

These and other features and advantages of the present invention will be more fully understood and appreciated in view of this specification, the drawings, and the claims.

### BRIEF DESCRIPTION OF THE DRAWINGS

FIG. 1 is a perspective cutaway view of a reinforced thermoplastic extrusion in accordance with an embodiment of the present invention.

FIG. 2 is a flow-chart illustrating a first method for forming the reinforced thermoplastic extrusion of FIG. 1

FIG. 3 is a flow-chart illustrating a second method for forming the reinforced thermoplastic extrusion of FIG. 1.

FIG. 4 is a flow-chart illustrating a method for forming a reinforced thermoplastic extrusion in accordance with another embodiment.

FIG. 5 is a perspective cut-away view of the reinforced thermoplastic extrusion of FIG. 1 including an enhanced thermoplastic polymer liner.

### DETAILED DESCRIPTION OF THE CURRENT EMBODIMENTS

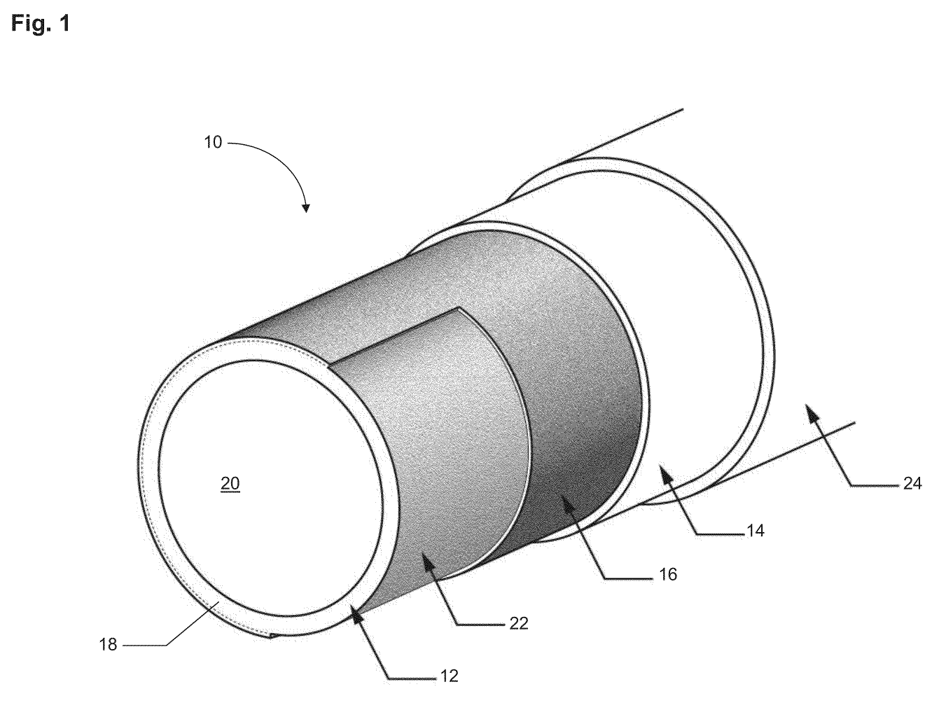

The invention as contemplated and disclosed herein includes a reinforced thermoplastic extrusion and a related method of manufacture. With reference to FIG. 1, a reinforced thermoplastic extrusion in accordance with one embodiment is illustrated and generally designated 10. The reinforced thermoplastic extrusion includes an inner tubular member 12, a reinforcing layer 14, and a vapor barrier 16 disposed between the tubular member 12 and the reinforcing layer 14.

More particularly, the inner tubular member 12 is a thermoplastic extrusion in the present embodiment, optionally a high density polyethylene (HDPE) extrusion. The inner tubular member 12 includes a sidewall 18 defining an inner surface 20 and an outer surface 22. The outer surface 22 is spaced apart from the inner surface 20 by a desired sidewall thickness, and is directly or indirectly bonded to the vapor barrier 16. The inner surface 20 forms a conduit for a moving fluid, for example an aqueous fluid, a gaseous fluid, and combinations thereof.

The moving fluid can include corrosive volatile hydrocarbons, for example acetone and methylene chloride, in contact with the inner surface 20. Under high pressures, volatile hydrocarbons from the moving fluid can diffuse radially outward through the tubular member sidewall 18. If allowed to contact the reinforcing layer 14, the volatile hydrocarbons can structurally weaken the reinforcing layer 14.

In order to limit transfer of the volatile hydrocarbons to the reinforcing layer 14, the vapor barrier 16 is positioned proximate the tubular member outer surface 22. The vapor barrier 16 can include an extrudate or a film layer adapted to limit the transfer of volatile hydrocarbons therethrough. In the present embodiment, the vapor barrier 16 includes a copolymer of ethylene, and in particular, ethylene vinyl alcohol (EVOH). In other embodiments, a different vapor barrier can be utilized. For example, the vapor barrier 16 can include polyamide-11 (Nylon-11). Also by example, an inorganic vapor barrier 16 can include a nano-particular, for example graphene, to prevent the transfer of volatile hydrocarbons therethrough.

In embodiments including an organic vapor barrier, including EVOH and/or polyamide-11, the reinforced extrusion 10 can include a tie layer. The tie layer is functionally an adhesive that is co-extruded with the tubular member 12. Alternatively, the tubular member outer surface 22 can be activated according to a corona treatment and/or a sulfurization treatment. After a corona treatment and/or a sulfurization treatment, the vapor barrier extrudate or film layer can be applied to the tubular member 12, optionally including one or more inorganic or organic additives. For example, the vapor barrier can include maleic anhydride to increase the bonding of the reinforcing layer 14 to the tubular member 12. Other additives can include functional polymers available under the trade name Amplify from the Dow Chemical Company of Midland, Mich. Still other additives may also be used as desired.

As noted above, the reinforced thermoplastic extrusion 10 includes a reinforcing layer 14. The reinforcing layer 14 includes an inner surface disposed toward the outer surface of the tubular member 12. The reinforcing layer 14 can include any material adapted to increase the burst strength of the tubular member 12. In the present embodiment, the reinforcing layer 14 includes a thermoplastic composite tape wound about the exterior of the carrier 12 and the vapor barrier 16. The thermoplastic composite tape can include directional fibers and/or woven fibers, the fibers including for example carbon, aramid, fiberglass, aluminum or titanium. The reinforcing fibers can be disposed in a hardened thermoplastic matrix material, optionally polyamide, polyethylene terephtalate, polyphenylene sulphide, polybutylene terephthalate, polysulfone, or polycarbonate.

Additional layers can also be added to the reinforced thermoplastic extrusion 10. As shown in FIG. 1 for example, an insulating layer or jacket 24 can be added to the exterior of the thermoplastic composite tape 14. The jacket 24 can be fused to the thermoplastic composite tape 14, which is fused to the tubular member 12 to form a multi-layer composite pipe for high pressure applications involving moving fluids having volatile hydrocarbons and other corrosive compounds.

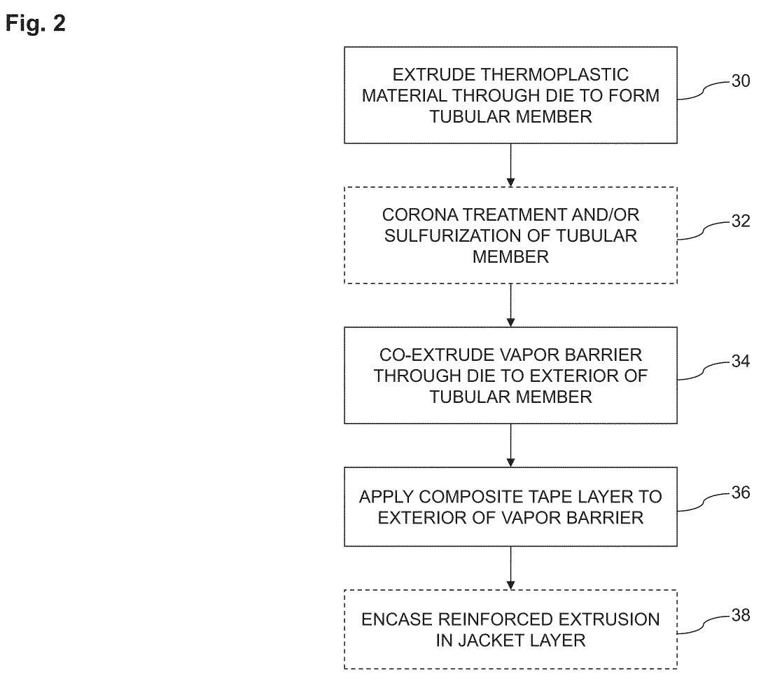

Referring now to the flow chart of FIG. 2, a method for forming a reinforced extrusion includes extruding a polymeric material into a tubular member at step 30, co-extruding with the tubular member a vapor barrier at step 34, and overwrapping the tubular member and the vapor barrier with a thermoplastic reinforcing layer at step 36. The polymeric material includes HDPE in the present embodiment, but can include other suitable thermoplastic materials as desired. The vapor barrier can include inorganic vapor transmission barriers, including for example a graphene, and organic vapor transmission barriers, including for example EVOH. Where an organic vapor barrier is utilized, the method can optionally include applying a corona treatment and/or a sulfurization treatment to the exterior of the tubular member at step 32. The addition of the corona treatment and/or sulfurization treatment can enhance the bonding of the extruded member to the vapor barrier extrudate. Once the thermoplastic tape is applied, an optional jacket layer can be applied through a die as an extrudate over the thermoplastic tape at step 38.

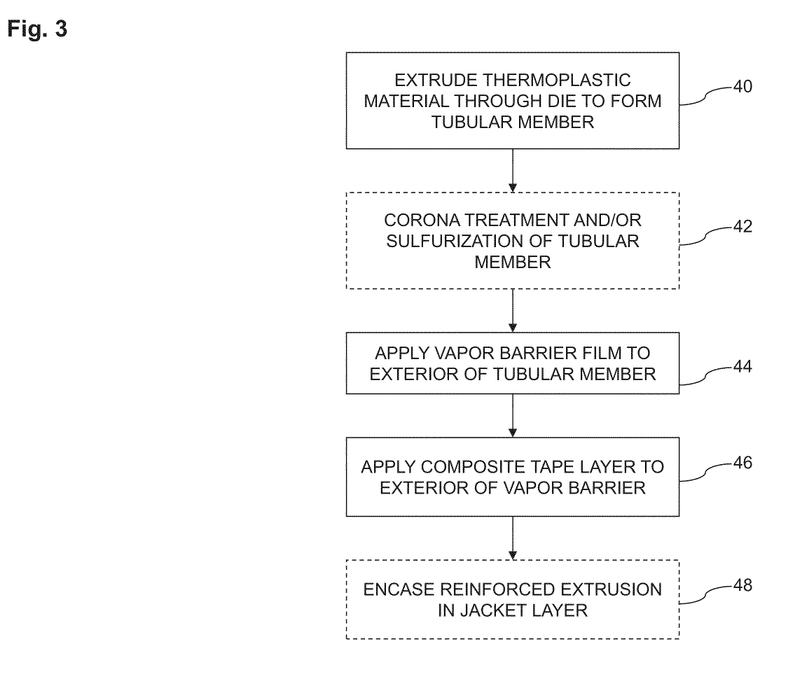

In a variation of the above method, the vapor barrier can be applied as a film to the exterior of the tubular member as generally shown in FIG. 3. Further with respect to FIG. 3, the reinforced thermoplastic member is formed by extruding a polymeric material into a tubular member at step 40, applying a vapor barrier film to the exterior of the tubular member at step 44, and overwrapping the tubular member with a thermoplastic reinforcing layer at step 46. The method can optionally include applying a corona treatment and/or a sulfurization treatment to the exterior of the tubular member at step 42 and/or applying a jacket layer through a die as an extrudate over the reinforced thermoplastic member at step 48.

During the extrusion of the tubular member at step 40, vacuum and “rapid” cooling of this extrusion takes place so that the tubular member holds dimension. This rapid cooling locks in place mechanical forces such as shrinkage, thereby creating a stressed condition in the tubular member. The process of applying and bonding a thermoplastic composite tape to this inner pipe at step 44 adds heat to some degree to the tubular member and allows the tubular member to anneal. This annealing process, through the application of the thermoplastic composite tape, allows the tubular member to release those locked-in forces created during the rapid cooling process. Since this thermoplastic composite tape or reinforcement layer is fully bonded to the tubular member, the annealing or shrinkage forces only have the effect of allowing the tubular member to shrink in two directions, length and a decrease in the overall inner diameter of the tubular member. Since no de-bonding occurs, the reinforced thermoplastic extrusion 10 is a pre-stressed thermoplastic composite pipe, not unlike pre-stressed concrete. Adhesion between the tubular member and the reinforcement layer prevents the formation of voids or de-bonding between the two layers.

The reinforced thermoplastic extrusion 10 can include coiled pre-stressed thermoplastic composite pipe of varying lengths. The intermediate vapor barrier 16 not only slows or prevents the transfer of volatile hydrocarbons therethrough, but also holds annealing or shrinkage forces without de-bonding, while also functioning as a shock absorbing layer. The vapor barrier 16 is optionally selected to include a relatively high elongation-to-break resin that is of the same chemistry as both the inner liner 12 and the thermoplastic composite tape 14. Such a resin can maintain bonding between the thermoplastic composite tape 14 and inner liner 12 during conditions of severe cold or high impact events. This can include an HDPE resin for an HDPE thermoplastic composite pipe with a Dow HDPE resin 8904 or other HDPE resins with similar elasticity characteristics, for example having elongation-to-break properties of 1200%. This resin also acts as a carrier resin for the vapor barrier enhancement. This resin can be selected for engineering purposes to hold and maintain the stress created during the annealing process.

Further, in instances where the reinforced thermoplastic extrusion is being coiled, the above methods of FIGS. 2-3 can include adding elastomeric polymers to the vapor barrier. The addition of elastomeric polymers to the vapor barrier can provide elasticity without debonding the reinforced thermoplastic extrusion. These elastomeric polymers that are added to the extrudate or film addition can be of the same or different chemistry from the vapor barrier itself. Where HDPE is utilized, there can be many different polyethylene chemistries that can be added to significantly increase the elongation-to-break ratio of the polymer itself. One such elastomer polymer includes a polyolefin elastomer available under the trade name Affinity from Dow Chemical Company of Midland, Mich.

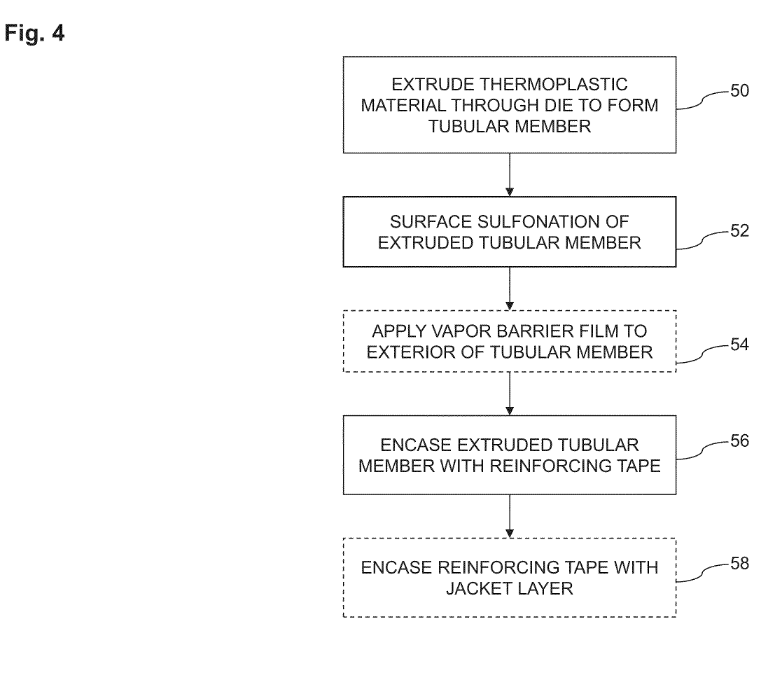

In still another variation of the above methods, a surface sulfonation process can be applied to the interior of the tubular member, the exterior of the tubular member, or both the interior and exterior of the tubular member. Surface sulfonation of an HDPE extrusion can substantially reduce the permeability of the tubular member to thereby limit the transfer of volatile hydrocarbons therethrough. In accordance with this method, and as generally depicted in FIG. 4, the reinforced tubular member is formed by extruding a polymeric material into a tubular member at step 50, reacting sulfur trioxide with the tubular member sidewall in a surface sulfonation process at step 54, and overwrapping the tubular member with a thermoplastic reinforcing layer at step 56.

Optionally, the method of FIG. 4 can include applying a vapor barrier extrudate or film to the exterior of the tubular extrusion at step 52. Further optionally, the method of FIG. 4 can include applying an optional jacket extrudate over the thermoplastic tape at step 58. Advantageously, the sulfonation of the tubular sidewall can diminish the vapor transmission of hydrocarbon volatiles through the tubular extrusion, while also improving the bond between the tubular extrusion and the reinforcing overwrap. The sulfonation of the tubular sidewall can also withstand temperatures in excess of the ability of an EVOH vapor barrier. Further, the reinforcing overwrap can remain in direct contact with the tubular extrusion without the addition of one or more tie layers therebetween.

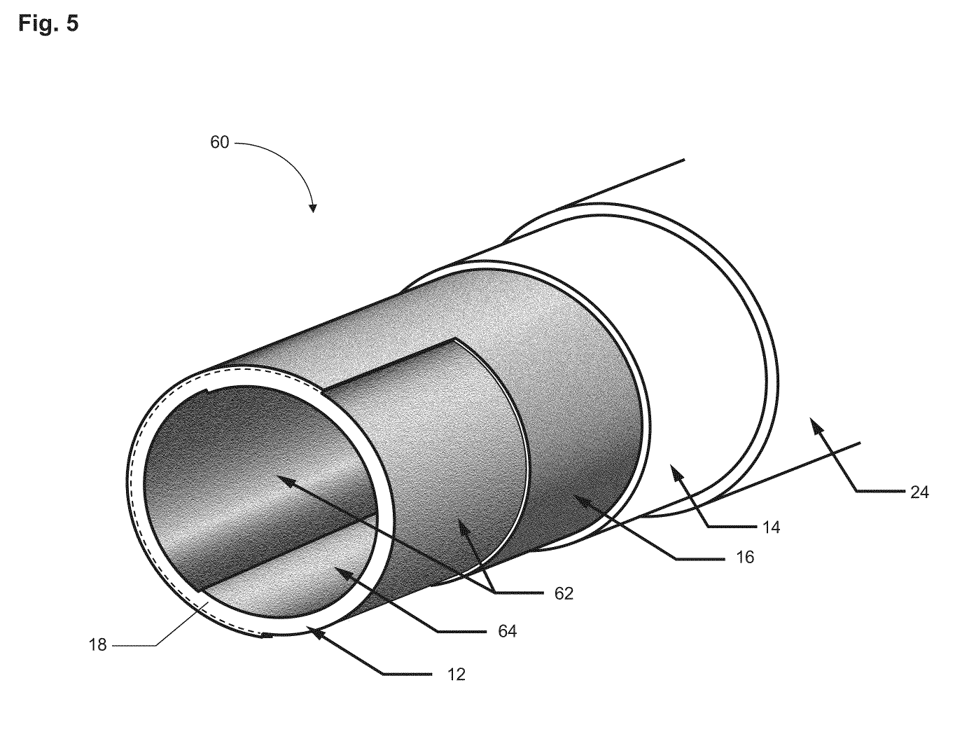

A reinforced thermoplastic extrusion in accordance with another embodiment is illustrated in FIG. 5 and generally designated 60. The reinforced thermoplastic extrusion 60 is structurally and functionally similar to the reinforced thermoplastic extrusion 10 of FIG. 1, and includes a) a sulfonation and/or corona treatment 62 on the inner surface 20 of the inner tubular member 12 and b) an enhanced thermoplastic polymer layer 64 on the treated inner surface 20 of the inner tubular member 12.

More particularly, the sulfonation and/or corona treatment 62 can substantially reduce the permeability of the tubular member to thereby limit the transfer of volatile hydrocarbons therethrough. Application of the sulfonation treatment 64 can include reacting sulfur trioxide with the tubular member sidewall after extrusion of the tubular member 12. The enhanced thermoplastic polymer layer 64 is then applied over the treated inner surface to additionally limit the transfer of volatile hydrocarbons therethrough. In the present embodiment, the enhanced thermoplastic polymer layer 64 includes a copolymer of ethylene, and in particular, EVOH. In other embodiments, the enhanced thermoplastic polymer layer 64 can include polyamide-11 (Nylon-11). Also by example, the enhanced thermoplastic polymer layer 64 can include a nano-particular, for example graphene, to prevent the transfer of volatile hydrocarbons therethrough.

The above description is that of current embodiments of the invention. Various alterations and changes can be made without departing from the spirit and broader aspects of the invention as defined in the appended claims, which are to be interpreted in accordance with the principles of patent law including the doctrine of equivalents. Any reference to elements in the singular, for example, using the articles “a,” “an,” “the,” or “said,” is not to be construed as limiting the element to the singular.

1. A method for forming a reinforced extrusion, the method comprising:
extruding a polymeric material into a tubular member;
applying a first vapor barrier to the tubular member; and
overwrapping the first vapor barrier with a thermoplastic reinforcing layer, the first vapor barrier being between the tubular member and the thermoplastic reinforcing layer to reduce the transfer of volatile hydrocarbons therethrough.

2. The method according to claim 1 further including decreasing the permeability of an inner surface of the tubular member to volatile hydrocarbons.

3. The method according to claim 2 further including applying a second vapor barrier to the inner surface of the tubular member.

4. The method according to claim 1 wherein applying the first vapor barrier includes co-extruding the first vapor barrier with the tubular member.

5. The method according to claim 1 wherein applying the first vapor barrier includes depositing a vapor barrier film to an exterior surface of the tubular member.

6. The method according to claim 1 further including encasing the thermoplastic reinforcing layer with a liner.

7. The method according to claim 1 wherein the polymeric material includes high density polyethylene and the first vapor barrier includes ethylene vinyl alcohol.

8. The method according to claim 1 wherein the first vapor barrier includes an elastomer to increase the elongation-to-break ratio of the tubular member.

9. The method according to claim 8 wherein the first vapor barrier includes a nano-particulate.

10. A reinforced extrusion comprising:
an extruded polymeric member including a sidewall defining an exterior surface;
a thermoplastic reinforcing layer encompassing the extruded polymeric member and defining an interior surface disposed toward the extruded polymeric member; and
an intermediate layer interposed between the extruded polymeric member and the thermoplastic reinforcing layer, wherein the intermediate layer is a polymeric vapor barrier bonded to at least one of the exterior surface of the extruded polymeric member and the interior surface of the thermoplastic reinforcing layer.

11. The reinforced extrusion of claim 10 wherein the vapor barrier includes ethylene vinyl alcohol.

12. The reinforced extrusion of claim 10 wherein the vapor barrier includes nylon-11 polyamide.

13. The reinforced extrusion of claim 10 wherein the vapor barrier includes graphene.

14. The reinforced extrusion of claim 10 wherein the extruded polymeric member exterior surface is subject to sulfurization to enhance bonding between the extruded polymeric member and the vapor barrier.

15. The reinforced extrusion of claim 10 wherein the extruded polymeric member exterior surface is subject to a corona treatment to enhance bonding between the extruded polymeric member and the vapor barrier.

16. A method for forming a reinforced extrusion, the method comprising:
extruding a polymeric material into a tubular member having an interior surface for receipt of a moving fluid and an exterior surface opposite the interior surface;
reacting at least one of the interior surface and the exterior surface of the tubular member with a sulfur-containing compound to decrease the permeability of the tubular member to volatile hydrocarbons; and
overwrapping the tubular member with a thermoplastic reinforcing layer.

17. The method according to claim 16 further including applying a vapor barrier to at least one of the exterior surface and the interior surface of the tubular member.

18. The method according to claim 16 further including applying a corona treatment to at least one of the exterior surface and interior surface of the tubular member.

19. The method according to claim 16 wherein the polymeric material includes high density polyethylene.

20. The method according to claim 16 wherein the tubular member is in direct contact with the tubular member exterior surface.

21. The method according to claim 16 wherein the sulfur-containing compound includes sulfur trioxide.

22. The method according to claim 16 wherein the sulfur-containing compound is reacted with the interior surface and the exterior surface.

23. The method according to claim 16 further including encasing the thermoplastic reinforcing layer with a liner.
